(19) United States
(12) Patent Application Publication
(10) Pub. No.: US 2010/0103031 A1
(43) Pub. Date: Apr. 29, 2010

(54) METHOD OF DETERMINING RELIABILITY OF LONG-TERM PREDICTED ORBIT DATA, METHOD OF PROVIDING LONG-TERM PREDICTED ORBIT DATA, AND INFORMATION PROVIDING APPARATUS

(75) Inventor: Kenji Onda, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/578,782

(22) Filed: Oct. 14, 2009

(30) Foreign Application Priority Data
Oct. 24, 2008 (JP) 2008-274560

(51) Int. Cl. G01S 1/00

(52) U.S. Cl. 342/357.02

(57) ABSTRACT

A method of determining the reliability of long-term predicted orbit data is disclosed. The method includes: analyzing a variation in the accuracy of the time-series predicted positions included in predicted position data by comparing the predicted positions included in the predicted position data, which is acquired by predicting a position of a positioning satellite in a time series, with actual positions of the positioning satellite corresponding to the predicted positions; and determining the reliability in each of the prediction periods of the long-term predicted orbit data including predicted satellite orbits in a plurality of successive prediction periods on the basis of the analysis result.

The entire disclosure of Japanese Patent Application No. 2008-274560, filed Oct. 24, 2008 is expressly incorporated by reference herein.

### BACKGROUND

1. Technical Field

The present invention relates to a method of determining the reliability of long-term predicted orbit data, a method of providing long-term predicted orbit data, and an information providing apparatus.

2. Related Art

A global positioning system (GPS) is widely known as a positioning system employing positioning signals and is used in positioning devices built in mobile phones and car navigation apparatuses. In the GPS, a positioning calculation of calculating a three-dimensional coordinate value indicating the position of a target apparatus and a clock error is carried out on the basis of information such as the positions of plural GPS satellites or the quasi-distance from the GPS satellites to the target apparatus.

In measuring the position using the GPS, satellite information such as the position, velocity, and direction of movement of the GPS satellite is first calculated on the basis of navigation data, such as almanac or ephemeris, which overlaps with a GPS satellite signal emitted from the GPS satellite. The almanac serves as an influential key to capturing a satellite but is not generally used in the positioning calculation, because the satellite information is of poor precision. On the other hand, the ephemeris serves as an influential key to capturing a satellite and can be also used in the positioning calculation, because the satellite information has excellent precision. Therefore, for example, when the positioning calculation is started without the ephemeris, the ephemeris should be acquired from the GPS satellite signal, thereby enhancing the TTFF (Time To First Fix).

Therefore, as a server and client system, a technique of allowing a server to predict long-term predicted ephemeris (long-term predicted orbit data), which is the ephemeris corresponding to a term of one week, and to provide the long-term predicted ephemeris to a positioning device as a client has been developed and disclosed, for example, in US-A-2002-188403 and US-A-2005-212700.

A method of defining the long-term predicted ephemeris in the same data format as a typical ephemeris can be considered as a method of defining the long-term predicted ephemeris. That is, a satellite orbit is approximated using Keppler's elliptical orbit model which is one of satellite orbit approximate models and the long-term predicted ephemeris is defined using values of parameters (hereinafter, referred to as “satellite orbit parameters”) of the model expression. A predicted satellite calendar (predicted position data) including predicted positions acquired by predicting at a time series future positions of a positioning satellite at a predetermined time interval is provided from a predetermined commercial system. The approximating calculation, using Keppler's elliptical orbit model, can be carried out using the predicted satellite calendar.

However, the predicted positions of the positioning satellite included in the predicted satellite calendar tend to be mismatched with the actual positions of the positioning satellite as it progresses toward the future. Accordingly, when the long-term predicted ephemeris is created by carrying out the approximating calculation using Keppler's elliptical orbit model, the satellite orbit calculated by the approximating calculation tends to be mismatched with the actual satellite orbit as it progresses toward the future from the creation time. In the past, since there was no technique of determining the reliability (whether it is suitable for positioning) of the created long-term predicted ephemeris after the long-term predicted ephemeris is once created, the positioning device having acquired the long-term predicted ephemeris from the server might carry out the positioning calculation using the long-term predicted ephemeris with low reliability.

### SUMMARY

An advantage of some aspects of the invention is that it provides a technique of determining the reliability of a long-term predicted ephemeris.

A first aspect of the invention is directed to a method of determining the reliability of long-term predicted orbit data, including: analyzing a variation in the accuracy of time-series predicted positions included in the predicted position data by comparing the predicted positions included in the predicted position data, which is acquired by predicting a position of a positioning satellite in a time series, with actual positions of the positioning satellite corresponding to the predicted positions; and determining the reliability in each of prediction periods of long-term predicted orbit data including predicted satellite orbits in a plurality of successive prediction periods on the basis of the analysis result.

According to another aspect of the invention, there is provided an information providing apparatus including: a creation unit creating long-term predicted orbit data including predicted satellite orbits in a plurality of successive prediction periods; an analysis unit analyzing a variation in the accuracy of time-series predicted positions included in the predicted position data by comparing the predicted positions included in the predicted position data, which is acquired by predicting a position of a positioning satellite in a time series, with actual positions of the positioning satellite corresponding to the predicted positions; a determination unit determining the reliability in each of the prediction periods of the long-term predicted orbit data created by the creation unit on the basis of the analysis result of the analysis unit; and a provision unit providing the long-term predicted orbit data created by the creation unit and the determination result of the determination unit to a positioning device.

According to the above-mentioned configuration, a variation in the accuracy of time-series predicted positions included in the predicted position data is analyzed by comparing the predicted positions included in the predicted position data, which is acquired by predicting a position of a positioning satellite in a time series, with actual positions of the positioning satellite corresponding to the predicted positions. The reliability of each of the prediction periods of the long-term predicted orbit data including predicted satellite orbits in a plurality of successive prediction periods is determined on the basis of the analysis result.

The actual position of the positioning satellite is a position where the positioning satellite was actually located. Accordingly, when the difference between the predicted position and the actual position of the positioning satellite is great, it can be said that the accuracy of the predicted position is low and the reliability of the predicted satellite orbit predicted on the basis of the predicted position is low. Therefore, it is possible to properly determine the reliability of the long-term predicted orbit data on the basis of the analysis result on the variation in the accuracy of the predicted position.

A second aspect of the invention is directed to the method of determining the reliability of long-term predicted orbit data of the first aspect, wherein the analyzing of the variation in accuracy includes: comparing the predicted positions included in each of a plurality of the predicted position data having different prediction times with the corresponding actual positions; and calculating a variation pattern of the accuracy of the predicted positions with the lapse of time when the positions of the positioning satellite are predicted in a time series by statistically processing the comparison result. The determining of the reliability may include determining the reliability of each of the prediction periods of the long-term predicted orbit data on the basis of the variation pattern.

According to this configuration, the predicted positions included in each of a plurality of predicted position data having different prediction times are compared with the corresponding actual positions. The variation pattern in the accuracy of the predicted positions is calculated by statistically processing the comparison results. The variation pattern can be said to be a standard pattern representing the variation in the accuracy of the predicted positions. The reliability of each of the prediction periods of the long-term predicted orbit data is determined on the basis of the calculated variation pattern.

A third aspect of the invention is directed to the method of determining the reliability of long-term predicted orbit data of the second aspect, wherein the predicted position data includes the predicted positions of a plurality of positioning satellites. The comparing of the predicted positions with the actual positions may include comparing the predicted positions of each of the positioning satellites with the actual positions. The calculation of the variation pattern may include calculating the standard variation pattern of the positioning satellites by statistically processing the comparison results of the positioning satellites.

According to this configuration, the predicted positions of the positioning satellites are compared with the actual positions and the comparison results of the positioning satellites are statistically processed, thereby calculating the standard variation pattern of the positioning satellites.

A fourth aspect of the invention is directed to the method of determining the reliability of long-term predicted orbit data of the third aspect, wherein the long-term predicted orbit data includes data in the prediction periods for the positioning satellites. Here, the method may further include relatively estimating the comparison results of the positioning satellites with respect to each other. The determining of the reliability may include correcting the variation pattern for each positioning satellite on the basis of the relative estimation result and determining the reliability of each of the long-term predicted orbit data in each of the prediction periods for each positioning satellite.

According to this configuration, the comparison results of the positioning satellites are relatively estimated with respect to each other, the variation pattern is corrected for each positioning satellite on the basis of the relative estimation result, and the reliability in each of the prediction periods of the long-term predicted orbit data is determined for each positioning satellite.

For the positioning satellite of which the comparison result is determined to be relatively excellent as the relative estimation result of the comparison results between the predicted positions and the actual positions in the positioning satellites, the variation pattern is corrected so that the reliability of the long-term predicted orbit data increases. On the contrary, for the positioning satellite of which the comparison result is determined to be relatively poor, the variation pattern is corrected so that the reliability of the long-term predicted orbit data decreases. Accordingly, it is possible to properly determine the reliability in consideration of the comparison results of the positioning satellites.

A fifth aspect of the invention is directed to the method of determining the reliability of long-term predicted orbit data of the third or fourth aspect, wherein the analyzing of the variation in accuracy includes collecting the comparison results of the predicted position data every prediction time of the predicted position data for each positioning satellite, and the determining of the reliability may include correcting the variation pattern for each positioning satellite on the basis of the time-series variation of the prediction times in the comparison results of the predicted position data, which are collected every prediction time, and determining the reliability of each prediction period of the long-term predicted orbit data for each positioning satellite.

According to this configuration, the comparison results of the predicted position data are collected every prediction time of the predicted position data for each positioning satellite. Then, the variation pattern for each positioning satellite is corrected on the basis of the time-series variation of the prediction times in the comparison results collected every prediction time of the predicted position data and the reliability in each prediction period of the long-term predicted orbit data is determined for each positioning satellite.

For the positioning satellite of which the comparison result of the predicted positions and the actual positions is improved with the lapse of time, the variation pattern is corrected so that the reliability of the long-term predicted orbit data increases. On the contrary, for the positioning satellite of which the comparison result is deteriorated with the lapse of time, the variation pattern is corrected so that the reliability of the long-term predicted orbit data decreases. Accordingly, it is possible to properly determine the reliability in consideration of the temporal variation of the comparison results.

A sixth aspect of the invention is directed to the method of determining the reliability of long-term predicted orbit data of the fifth aspect, wherein the determining of the reliability includes correcting the variation pattern and then determining the reliability for only the positioning satellite of which the comparison result of the predicted positions with the actual positions does not satisfy a predetermined inferior condition, out of the plurality of positioning satellites.

According to this configuration, the variation pattern is corrected and then the reliability is determined for only the positioning satellite of which the comparison result of the predicted positions with the actual positions does not satisfy a predetermined inferior condition, out of the plurality of positioning satellites. For the positioning satellite of which the comparison result of the predicted positions with the actual positions satisfies a predetermined inferior condition, it is estimated that a particular reason (for example, correction of a satellite orbit) for greatly deviating the predicted position from the actual position appears and thus the variation pattern is not corrected.

A seventh aspect of the invention is directed to a method of providing long-term predicted orbit data, including: creating long-term predicted orbit data; determining the reliability of the created long-term predicted orbit data using any of the methods of determining the reliability of long-term predicted orbit data of the first to sixth aspects; and providing the created long-term predicted orbit data and the determination result to a positioning device.

According to this configuration, the long-term predicted orbit data is created and the reliability of the created long-term predicted orbit data is determined using the above-mentioned method of determining the reliability of the long-term predicted orbit data. Then, the created long-term predicted orbit data and the determination result of the reliability are provided to a positioning device. Accordingly, the positioning device can be made not to use the data with low reliability for the positioning at the time of the positioning using the provided long-term predicted orbit data.

### BRIEF DESCRIPTION OF THE DRAWINGS

The invention will be described with reference to the accompanying drawings, wherein like numbers reference like elements.

FIG. 1 is a diagram schematically illustrating the configuration of a positioning system.

FIG. 2 is a diagram illustrating a predicted satellite calendar and a precise satellite calendar.

FIG. 3 is a graph illustrating period average measurement errors.

FIG. 4 is a diagram illustrating the course of determining a correction value of a standard pattern.

FIG. 5 is a block diagram illustrating the functional configuration of a server system.

FIG. 6 is a diagram illustrating an example of data stored in a ROM of the server system.

FIG. 7 is a diagram illustrating an example of data stored on a hard disk of the server system.

FIG. 8 is a diagram illustrating the table structure of a measurement error-basic value correlation table.

FIG. 9 is a diagram illustrating the data structure of a predicted satellite calendar database.

FIG. 10 is a diagram illustrating the data structure of a precise satellite calendar database.

FIG. 11 is a diagram illustrating the data structure of a measurement error database.

FIG. 12 is a diagram illustrating the data structure of standard pattern data.

FIG. 13 is a diagram illustrating the data structure of long-term predicted ephemeris data.

FIG. 14 is a diagram illustrating the data structure of a predicted ephemeris.

FIG. 15 is a flowchart illustrating the flow of a long-term predicted ephemeris providing process.

FIG. 16 is a flowchart illustrating the flow of a long-term predicted ephemeris creating process.

FIG. 17 is a flowchart illustrating the flow of the long-term predicted ephemeris creating process.

FIG. 18 is a flowchart illustrating the flow of a second long-term predicted ephemeris creating process.

### DESCRIPTION OF EXEMPLARY EMBODIMENTS

Hereinafter, exemplary embodiments of the invention will be described with reference to the accompanying drawings. However, the invention is not limited to the exemplary embodiments.

### 1. System Configuration

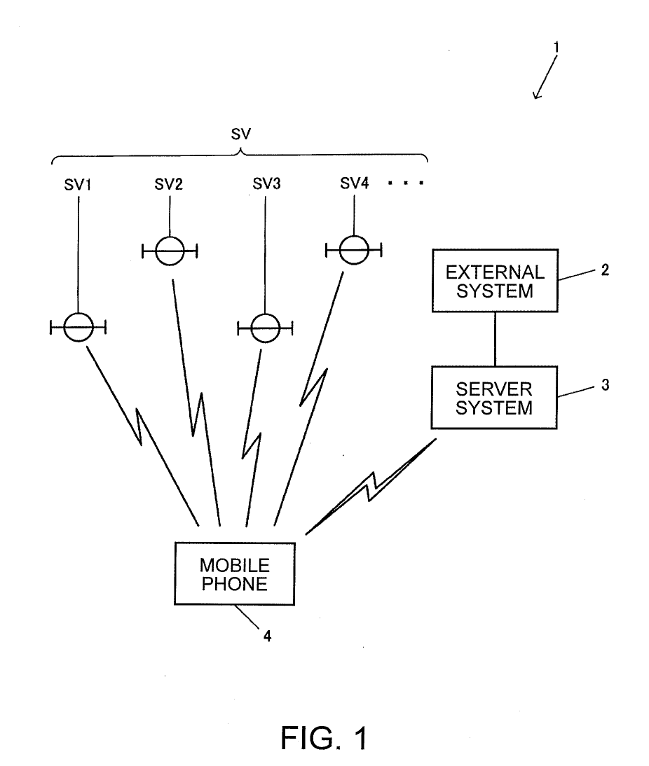

FIG. 1 is a diagram schematically illustrating the configuration of a positioning system 1 according to an exemplary embodiment. The positioning system 1 includes an external system 2, a server system 3 which is a kind of information providing apparatus, a mobile phone 4 which is a kind of electronic apparatus having a positioning device, and plural GPS satellites SV (SV1, SV2, SV3, SV4, . . . ) which are kinds of positioning satellites. The positioning calculation can be carried out using the mobile phone 4 and the GPS satellites SV, after the mobile phone 4 acquires the necessary data from the server system 3. Accordingly, the mobile phone 4 and the GPS satellites SV constitute one positioning system. The server system 3 and the mobile phone 4 can be called a positioning system as an earth-side system.

The external system 2 is a known system for periodically receiving satellite signals from the GPS satellites SV, creating a predicted satellite calendar on the basis of the navigation data included in the received satellite signals, and providing the created predicted satellite calendar to the server system 3. The predicted satellite calendar provided from the external system 2 has position data in which the predicted positions acquired by predicting the future positions of the GPS satellites SV and predicted clock errors acquired by predicting the errors of atomic clocks built in the GPS satellites SV are arranged at a predetermined time interval (for example, an interval of 15 minutes) in a time series.

The external system 2 also provides past data in addition to the predicted satellite calendars as future data. That is, the external system 2 creates a precise satellite calendar, which includes actual positions at which the GPS satellites SV are actually located and actual clock errors which are the actual errors of the atomic clocks built in the GPS satellites SV, as the past factual data and provides the created precise satellite calendar to the server system 3. Since the methods of calculating the actual positions and the actual clock errors are widely known, a detailed description will be omitted. For example, the external system 2 is a private or public computer system which provides predicted satellite calendars or precise satellite calendars.

The server system 3 is a system having a server acquiring the predicted satellite calendars and the precise satellite calendars from the external system 2 and creating and providing an ephemeris (hereinafter, referred to as a “long-term predicted ephemeris” in this embodiment or a “long-term predicted orbit data” because it is an orbit valid for a long term) valid for a long term of at least one day, for example, one week, as the predicted ephemeris of all the GPS satellites SV using the acquired predicted satellite calendars and the precise satellite calendars.

The mobile phone 4 is an electronic apparatus used for a user to communicate or to transmit and receive mail and has a positioning device performing a position measuring function (positioning function) in addition to the inherent functions of the mobile phone of communicating or transmitting and receiving mail. The mobile phone 4 transmits a request signal for the long-term predicted ephemeris to the server system 3 by the user's operation and receives the long-term predicted ephemeris from the server system 3. The mobile phone 4 captures the GPS satellites SV using the received long-term predicted ephemeris and carries out the positioning calculation based on the satellite signals.

### 2. Principle

The server system 3 performs a process of creating the long-term predicted ephemeris using the predicted satellite calendar acquired from the external system 2. Specifically, the period from the creation time of the long-term predicted ephemeris to a time after one week is used as a “creation period” and the creation period is divided into plural periods (hereinafter, referred to as “prediction periods”) when a satellite orbit is approximated and modeled. In this embodiment, the magnitudes of the prediction periods are uniformly 6 hours. That is, a creation period of one week is divided into 28 prediction periods (first prediction period to twenty-eighth prediction period) every 6 hours.

The server system 3 extracts the predicted position in each prediction period out of the predicted positions included in the predicted satellite calendar acquired from the external system 2. Keppler's satellite orbit model expression (hereinafter, also referred to as an “approximate model”) in which the square sum of the distances from all the extracted predicted positions is the least is calculated on the respective prediction periods. The parameters of the calculated approximate model expression of the satellite orbit are referred to as the “satellite orbit parameters” and the calculation for the approximate model is also referred to as the “approximating calculation”. The satellite orbit acquired by the approximating calculation is referred to as the “predicted orbit”. The long-term predicted ephemeris is data including the values of the satellite orbit parameters in all the prediction periods for all the GPS satellites.

The predicted positions of the GPS satellites SV included in the predicted satellite calendar tend to be mismatched with the actual positions of the GPS satellites SV as it progresses toward the future. Accordingly, when the long-term predicted ephemeris is created by carrying out the approximating calculation, the predicted orbit calculated by the approximating calculation tends to be mismatched with the actual satellite orbit as it progresses toward the future from the creation time.

In this embodiment, the server system 3 determines “predicted orbit reliability” which is an indicator value representing the reliability of the predicted orbit for each prediction period of each GPS satellite and provides the determined predicted orbit reliability as a reliability parameter to the mobile phone 4 along with the long-term predicted ephemeris. In this embodiment, the predicted orbit reliability is expressed by 13 steps of “0” to “12”, where “0” represents the highest reliability of the predicted orbit and “12” represents the lowest reliability of the predicted orbit. The numerical range of the predicted orbit reliability can be properly changed and set and, for example, can be expressed by 16 steps of “0” to “15”. The predicted orbit reliability is a value corresponding to the “URA index” included in the ephemeris.

A specific method of determining the predicted orbit reliability will be described now with reference to the drawings. In this embodiment, the predicted orbit reliability included in the long-term predicted ephemeris is determined using combinations (hereinafter, referred to as “satellite calendar combinations”) of plural predicted satellite calendars having different start times and precise satellite calendars (precise satellite calendars having the same start time) corresponding to the predicted satellite calendars. The start time means the time of the oldest satellite position out of the satellite positions included in each predicted satellite calendar and each precise satellite calendar.

In this embodiment, the predicted orbit reliability is determined using the predicted satellite calendars having start times different by four hours and the precise satellite calendars corresponding thereto. Each predicted satellite calendar and each precise satellite calendar include the data of satellite positions and clock errors corresponding to one week and 28 periods acquired by dividing one week into groups of 6 hours are referred to as “a first period to a twenty-eighth period” for the purpose of convenience. However, the predicted satellite calendar and the precise satellite calendar actually have a data structure in which the satellite positions and the clock errors are arranged and are not divided into period groups.

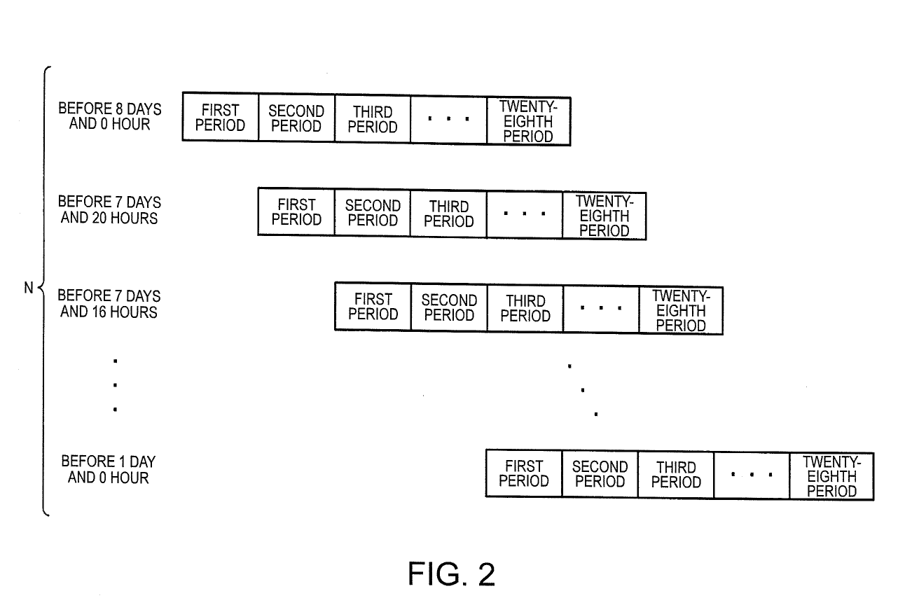

More specifically, for example, as shown in FIG. 2, like a satellite calendar combination having a start time before 8 days and 0 hour from the present time, a satellite calendar combination having a start time before 7 days and 20 hours, a satellite calendar combination having a start time before 7 days and 16 hours, . . . , and a satellite calendar combination having a start time before 1 day and 0 hour, N satellite calendar combinations having different start times are extracted. In FIG. 2, one band represents one predicted satellite calendar and one precise satellite calendar. By comparing the predicted positions included in the extracted predicted satellite calendars with the actual positions included in the precise satellite calendars to analyze the accuracy of the predicted position, the reliability of the predicted orbit is determined.

### (1) Calculation of Measurement Error

At the time of determining the predicted orbit reliability, the “measurement error” is calculated using the predicted positions at the times (times with an interval of 15 minutes included in the predicted satellite calendar) included in the predicted satellite calendar and the actual positions at the times (times with an interval of 15 minutes included in the precise satellite calendar) included in the corresponding precise satellite calendar for each satellite calendar combination.

Specifically, the measured position is first calculated using the predicted position at a certain time and the actual position at the same time. The measured position is calculated as a middle position between the position obtained by projecting the predicted position onto the surface of the earth and the position obtained by projecting the actual position onto the surface of the earth. That is, the coordinate of the intersection at which a line connecting the predicted position to the center of the earth intersects the surface of the earth (with an elevation of 0 m) and the coordinate of the intersection at which a line connecting the actual position to the center of the earth intersects the surface of the earth (with an elevation of 0 m) are calculated. Then, a position indicated by the coordinate of the middle point between two intersections is set as the measured position. The measured positions are calculated using a so-called elevation projection method. The above-mentioned calculation of the measured position is performed on the times included in the predicted satellite calendar.

When the measured positions have been calculated, the distance (hereinafter, referred to as a “first measured distance”) between the predicted position and the measured position and the distance (hereinafter, referred to as a “second measured distance”) between the actual position and the measured position are calculated at each time included in the predicted satellite calendar and the distance between the first measured distance and the second measured distance is calculated as a “measured distance error”.

Subsequently, by multiplying the predicted clock error by the speed of light at the times included in the predicted satellite calendar, the distance-converted value (hereinafter, referred to as a “first clock error distance”) of the predicted clock error is calculated. Similarly, by multiplying the actual clock error by the speed of light at the times included in the precise satellite calendar, the distance-converted value (hereinafter, referred to as a “second clock error distance”) of the actual clock error is calculated. The difference between the first clock error distance and the second clock error distance is calculated as a “clock distance error”.

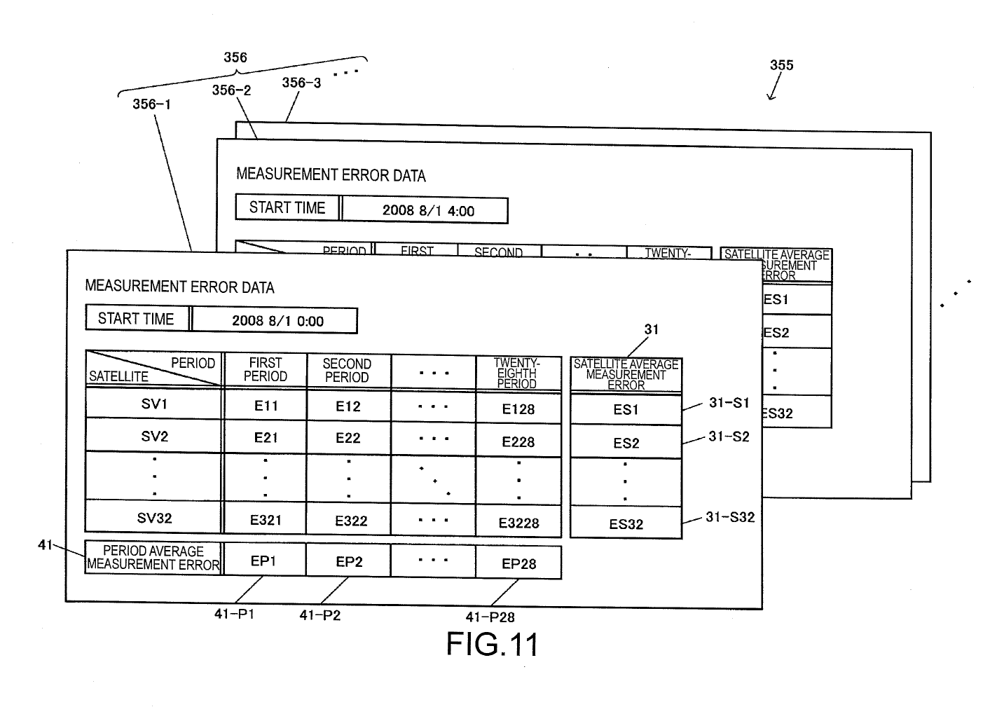

The measurement error can be calculated as the sum of the measured distance error and the clock distance error. In this way, the measurement errors for each of the periods of all the GPS satellites are calculated for all the satellite calendar combinations. Then, the measurement error data 356 shown in FIG. 11 is created and stored in the measurement error database 355.

The measurement error database 355 is a database in which the measurement error data 356 is stored by the start times of the predicted satellite calendars (precise satellite calendars). The measurement error data 356 includes the first to twenty-eighth periods and the measurement errors of the GPS satellites SV1 to SV32, which are correlated with the start times. In addition, the measurement error data 356 includes satellite average measurement errors 31 (31-S1, 31-S2, . . . , 31-S32) acquired by calculating the average of the measurement errors by GPS satellites and period average measurement errors (41-P1, 41-P2, . . . , 41-P28) acquired by calculating the average of the measurement errors by periods.

### (2) Setting of Standard Pattern

By statistically processing the measurement errors, a “standard pattern” which is a standard variation pattern of the predicted orbit reliability is set. For example, the standard pattern may be set by randomly selecting one satellite calendar combination out of N satellite calendar combinations, or the final standard pattern may be set by preparing and averaging temporary standard patterns of N satellite calendar combinations. Hereinafter, it is assumed that one satellite calendar combination is randomly selected.

Specifically, the measurement error data 356 corresponding to the start time of the selected satellite calendar combination is extracted from the measurement error database 355 and the period average measurement error 41 included in the extracted measurement error data 356 is read.

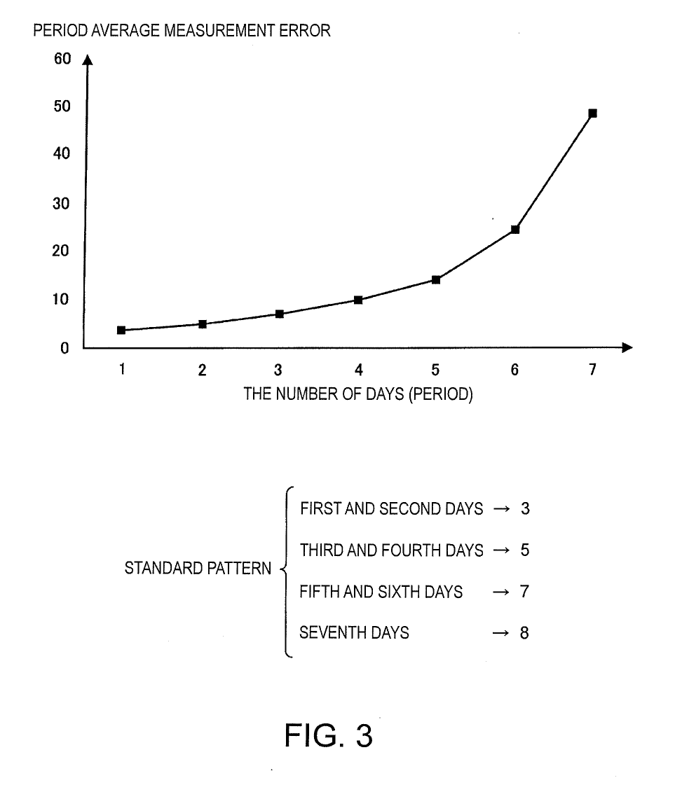

FIG. 3 is a graph illustrating the period average measurement errors. In FIG. 3, the horizontal axis represents the number of days (period) and the vertical axis represents the period average measurement error. The period is divided into the first to twenty-eighth periods. Since the length of the respective periods is 6 hours in this embodiment, the first to fourth periods correspond to the first day, the fifth to eighth periods correspond to the second day, . . . , and the twenty-fifth to twenty-eighth periods correspond to the seventh day.

The predicted positions included in the predicted satellite calendar tend to decrease in accuracy as it progresses toward the future from the start time. When the accuracy is low, the difference (measured distance error) between the measured distance (first measured distance) calculated from the predicted position and the measured position and the measured distance (second measured distance) calculated from the actual position and the measured position increases, whereby the measurement error increases. Accordingly, as shown in FIG. 3, the period average measurement error tends to increase as it progresses toward the future.

As the measurement error becomes great, it can be considered that the accuracy of the predicted position decreases and the reliability of the predicted orbit also decreases. The predicted orbit reliability is an indicator value representing that the reliability of the predicted orbit decreases as the value becomes greater. Therefore, the standard pattern is set so that the greater standard value is set for the period having the greater period average measurement error.

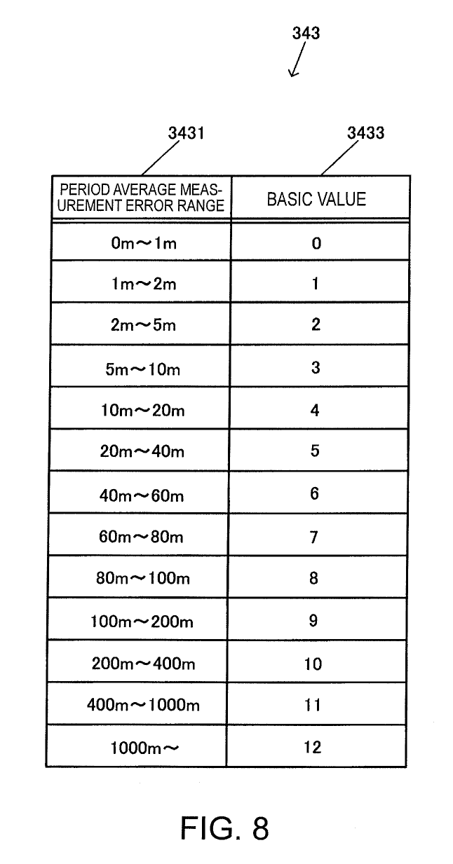

Specifically, as shown in FIG. 8, a table in which the period average measurement errors and basic values are correlated is prepared in advance. For example, the standard pattern is set by specifying the numerical range including the period average measurement errors by days and correlating the basic values corresponding to the specified numerical range with the corresponding days. In FIG. 3, as the standard pattern, “3” is set for the first day and the second day (first to eighth periods), “5” is set for the third day and the fourth day (ninth to sixteenth periods), “7” is set for the fifth day and the sixth day (seventeenth to twenty-fourth periods), and “8” is set for the seventh day (twenty-fifth to twenty-eighth periods).

### (3) Correction of Standard Pattern

The predicted orbit reliability is determined by correcting the set standard pattern. Specifically, the correction value of the standard pattern is determined by relatively estimating the satellite average measurement errors 31 calculated for all the GPS satellites at all the start times for the GPS satellites with reference to the measurement error data 356 stored in the measurement error database 355 of FIG. 11.

The correction value of the standard pattern can be set to “−1” for the GPS satellite having a relatively small satellite average measurement error, “+1” for the GPS satellite having a relatively great satellite average measurement error, and “±0” for the other GPS satellites. Of course, a greater value (for example, “+2” or “+3”) may be used as the correction value, or a smaller value (for example, “−2” or “−3”) may be used as the correction value.

Specifically, the average of all the satellite average measurement errors and the standard deviation of the satellite average measurement errors are first calculated. Then, for example, the value which is obtained by subtracting the standard deviation from the calculated average is set as a first threshold value and the value which is obtained by adding the standard deviation to the calculated average is set as a second threshold value. The correction value for the GPS satellite having such a tendency that the satellite average measurement error is smaller than the first threshold value is set to “−1”, the correction value for the GPS satellite having such a tendency that the satellite average measurement error is equal to or greater than the first threshold value and equal to or smaller than the second threshold value is set to “±0”, and the correction value for the GPS satellite having such a tendency that the satellite average measurement error is greater than the second threshold value is set to “+1”. The first threshold value and the second threshold value can be properly set using a method other than the above-mentioned method.

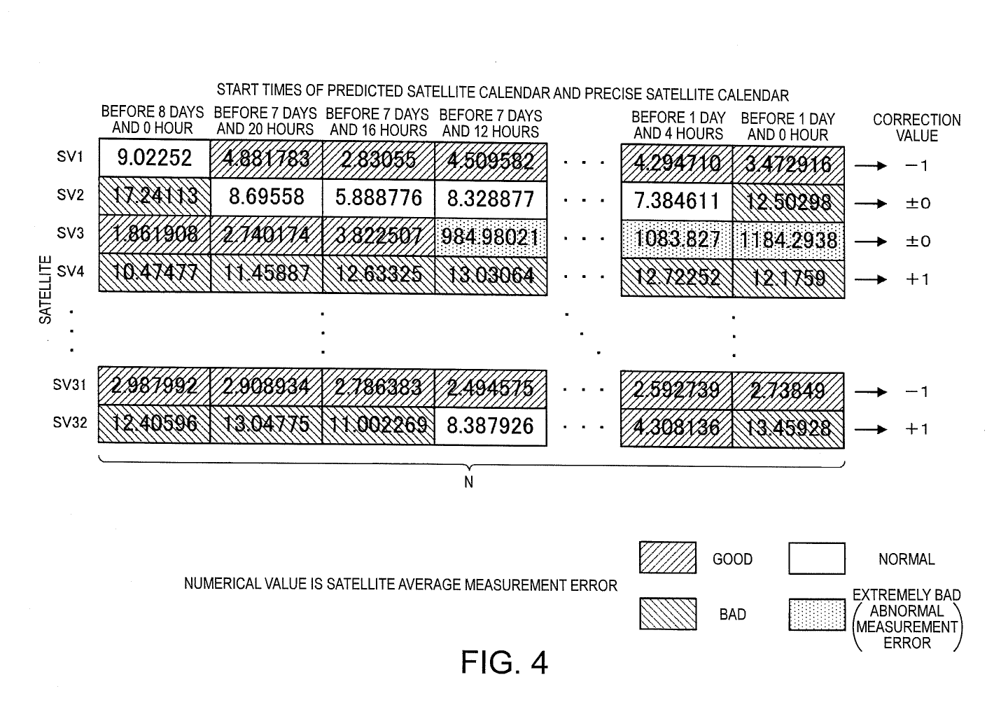

For example, in FIG. 4, the correction value of the GPS satellite “SV1” is set to “−1” since it is determined that it has a relatively small satellite average measurement error, and the correction value of the GPS satellite “SV4” is set to “+1” since it is determined that it has a relatively great satellite average measurement error. Since it is determined that the GPS satellite “SV2” has neither a great nor a small satellite average measurement error, its correction value is set to “±0”.

A GPS satellite periodically or non-periodically performs an orbit correcting process to correct the orbit around the earth. When the orbit correcting process is performed, the predicted positions after the orbit correcting process is performed, out of the predicted positions included in the predicted satellite calendars, greatly deviate from the actual positions and thus the predicted positions after the orbit correcting process is performed have a particularly great measurement error value. Here, the particularly great measurement error value due to the orbit correction, or the like, is referred to as “abnormal measurement error”.

In this embodiment, the correction value for the GPS satellite (the GPS satellite of which the measurement error satisfies the inferior condition) having plural abnormal measurement errors is set to “±0”. That is, exceptionally, the standard pattern is not corrected for the GPS satellite having plural abnormal measurement errors. For example, in FIG. 4, since plural abnormal measurement errors are measured in the GPS satellite “SV3”, the correction value thereof is set to “±0”.

When the correction value of the standard pattern is determined, the predicted orbit reliability is determined by correcting the standard pattern using the correction value. Specifically, the standard patterns of the first to twenty-eighth periods are corrected using the correction value and the corrected values are used as the predicted orbit reliability of the first to twenty-eighth prediction periods of the long-term predicted ephemeris.

### 3. Functional Configuration

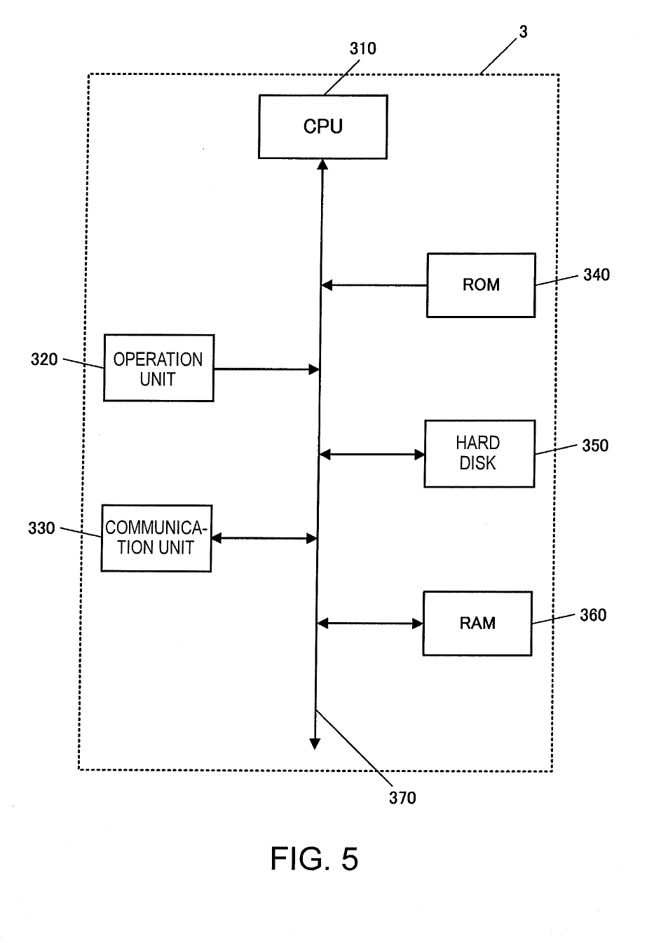

FIG. 5 is a block diagram illustrating the functional configuration of the server system 3. The server system 3 is a computer system which includes a CPU (Central Processing Unit) 310, an operation unit 320, a communication unit 330, a ROM (Read Only Memory) 340, a hard disk 350, and a RAM (Random Access Memory) 360 and in which the units are connected to each other with an additional bus 370.

The CPU 310 is a processor generally controlling the units of the server system 3 in accordance with a system program stored in the ROM 340. In this embodiment, the CPU 310 performs a process of providing the long-term predicted ephemeris to the mobile phone 4 in accordance with a long-term predicted ephemeris providing program 341 stored in the ROM 340.

The operation unit 320 is an input device receiving an operation instruction from an administrator of the server system 3 and outputting a signal corresponding to the operation to the CPU 310. This function is embodied, for example, by a keyboard, buttons, a mouse, and the like.

The communication unit 330 is a communication device exchanging a variety of data used in the system with the external system 2 or the mobile phone 4 via a communication network such as the Internet.

The ROM 340 is a nonvolatile memory device dedicated to reading and stores various programs such as a system program for allowing the CPU 310 to control the server system 3, a program for providing the long-term predicted ephemeris to the mobile phone 4, and a program for creating the long-term predicted ephemeris and various data.

The hard disk 350 is a memory device which data can be read from and written to using a magnetic head, or the like, and stores programs or data for performing various functions of the server system 3, similarly to the ROM 340.

The RAM 360 is a readable-writable volatile memory device and constitutes a work area temporarily storing various processing programs such as the system program and the long-term predicted ephemeris providing program executed by the CPU 310, data in the process of various processes, processing results, and the like.

### 4. Data Structure

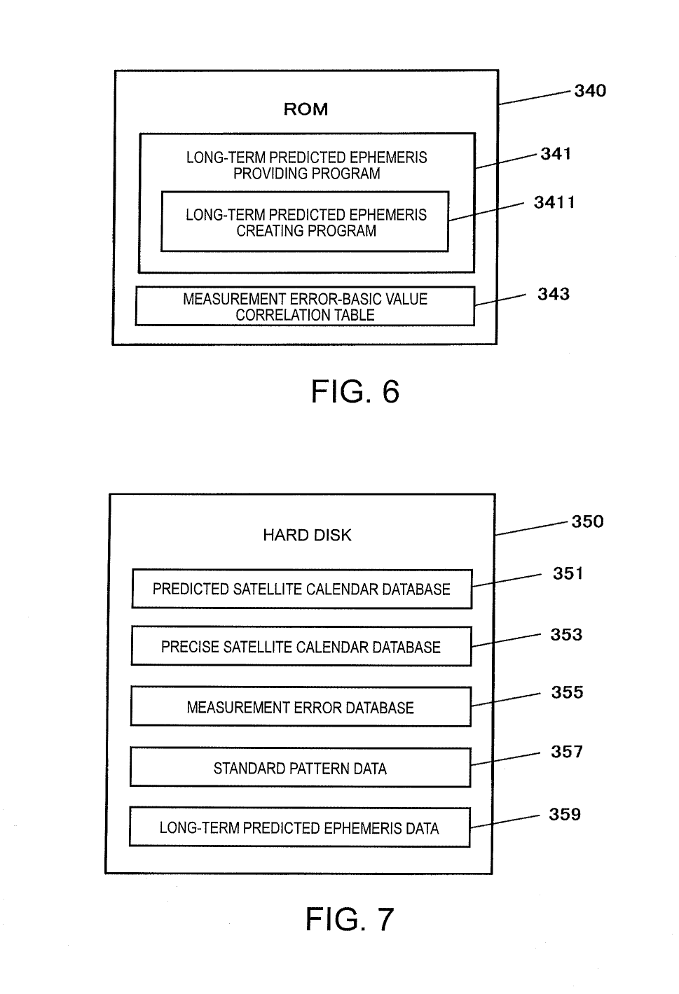

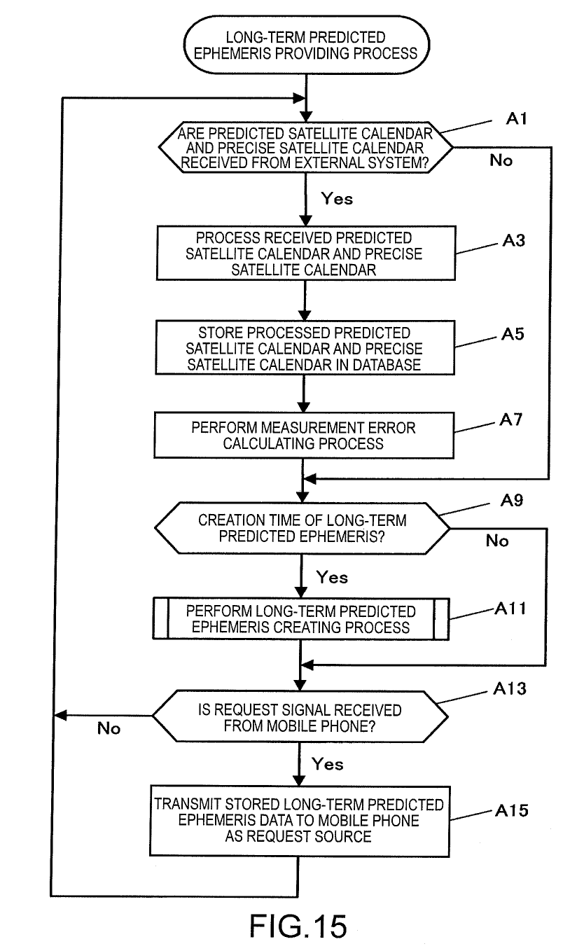

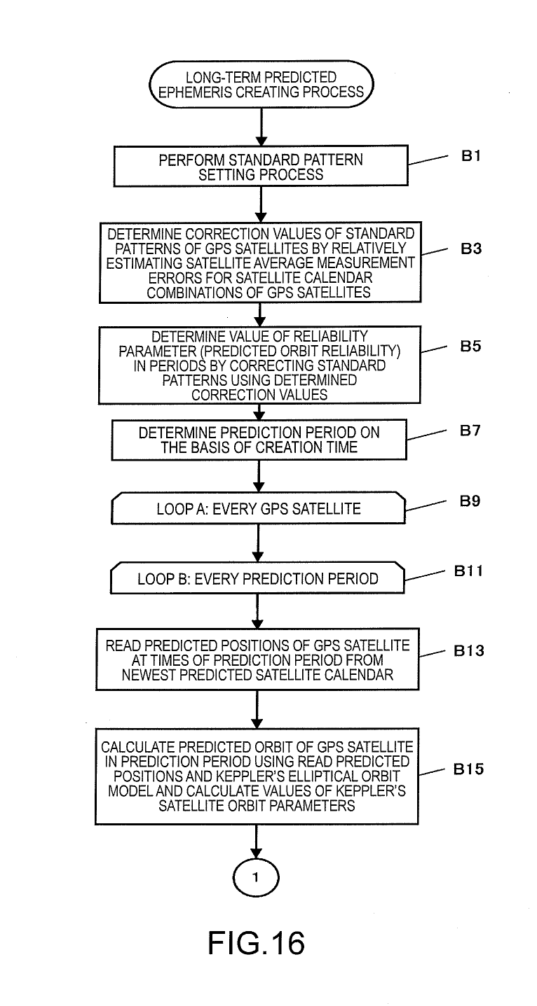

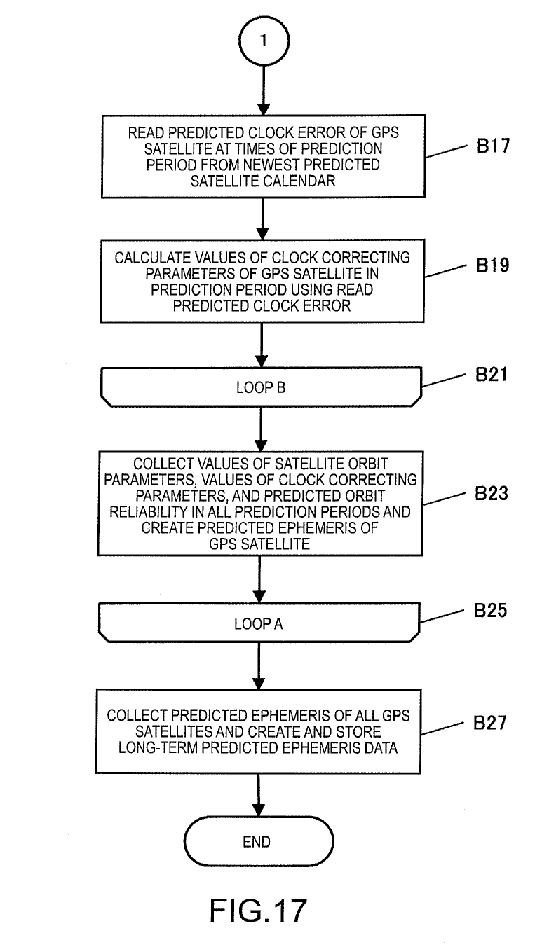

FIG. 6 is a diagram illustrating an example of data stored in the ROM 340. The ROM 340 stores a long-term predicted ephemeris providing program 341 read and executed in a long-term predicted ephemeris providing process (see FIG. 15) by the CPU 310 and a measurement error-basic value correlation table 343. The long-term predicted ephemeris providing program 341 includes a long-term predicted ephemeris creating program 3411 executed in a long-term predicted ephemeris creating process (see FIGS. 16 and 17) as a sub routine.

The long-term predicted ephemeris providing process is a process of allowing the CPU 310 to periodically create the long-term predicted ephemeris data 359 and transmitting the created long-term predicted ephemeris data 359 to the mobile phone 4 as a request source when receiving a request signal for the long-term predicted ephemeris data 359 from the mobile phone 4. The long-term predicted ephemeris providing process will be described in detail later with reference to a flowchart.

The long-term predicted ephemeris creating process is a process of allowing the CPU 310 to create the long-term predicted ephemeris data 359. In this embodiment, the CPU 310 creates the long-term predicted ephemeris data 359 once every four hours. The long-term predicted ephemeris creating process will also be described in detail later with reference to a flowchart.

FIG. 8 is a diagram illustrating the table structure of the measurement error-basic value correlation table 343. The measurement error-basic value correlation table 343 stores the period average measurement error ranges 3431 which are ranges including the period average measurement errors and basic values 3433 which are set for the periods in which the period average measurement errors are included in the corresponding period average measurement error range 3431, which are correlated with each other. For example, the period in which the period average measurement error is included in the range of “20 m to 40 m” is set to “5”. In the long-term predicted ephemeris creating process, the CPU 310 sets the standard pattern using the measurement error-basic value correlation table 343.

FIG. 7 is a diagram illustrating an example of data stored on the hard disk 350. The hard disk 350 stores a predicted satellite calendar database 351, a precise satellite calendar database 353, a measurement error database 355, standard pattern data 357, and long-term predicted ephemeris data 359.

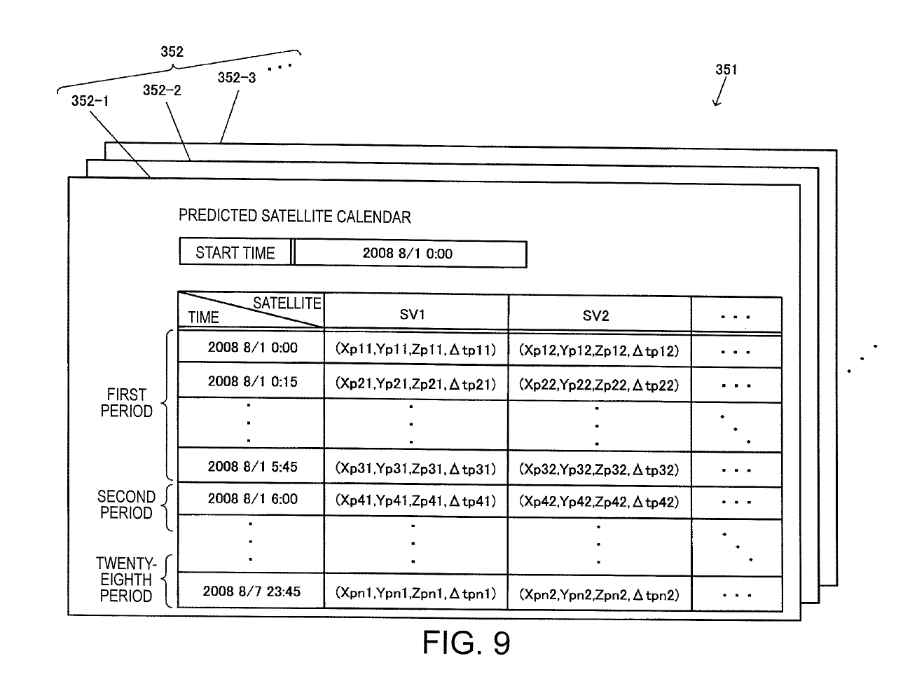

FIG. 9 is a diagram illustrating the data structure of the predicted satellite calendar database 351. The predicted satellite calendar database 351 includes plural predicted satellite calendars 352 (352-1, 352-2, 352-3, . . . ) in a time series. The predicted satellite calendars 352 are discrete data in which the predicted positions and the predicted clock errors for one week of the GPS satellites SV are arranged with the interval of 15 minutes and where data is collected every start time. For the purpose of convenience, 28 periods of a first period to a twenty-eighth period are constructed by dividing the period of one week into groups every 6 hours.

For example, the predicted satellite calendar 352-1 is data of which the start time is “0:00 of Aug. 1, 2008”. The predicted position of the GPS satellite “SV2” at “5:45 on Aug. 1, 2008”, is “(Xp32, Yp32, Zp32)” and the prediction error of the atomic clock is “Δtp32”.

The CPU 310 periodically (for example, every 4 hours) receives the predicted satellite calendars from the external system 2. Then, the CPU performs a process of processing a data format to store the received predicted satellite calendars in the predicted satellite database 351. Specifically, plural predicted satellite calendars 352 including data having different start times and the same creation period (for example, one week) of the long-term predicted ephemeris are created and stored in the predicted satellite calendar database 351.

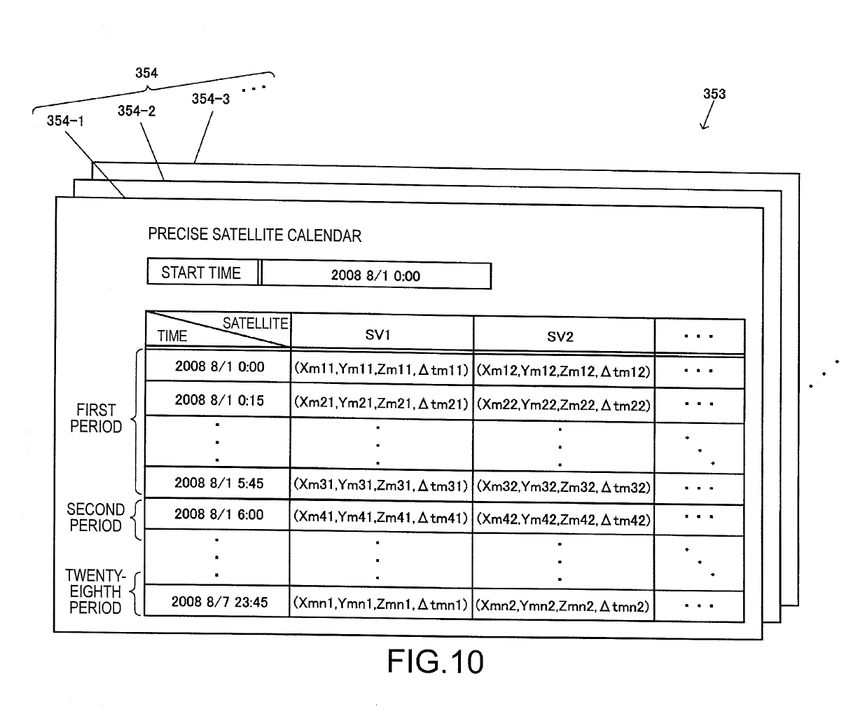

FIG. 10 is a diagram illustrating the data structure of the precise satellite calendar database 353. The precise satellite calendar database 353 stores plural precise satellite calendars 354 (354-1, 354-2, 354-3, . . . ) in a time series. The precise satellite calendars 354 have discrete data in which the actual positions of the GPS satellites SV corresponding to one week and actual clock errors with an interval of 15 minutes are stored and which are data collected each start time. By dividing the period of one week into groups every 6 hours, 28 periods of the first to the twenty-eighth period are constructed.

For example, the precise satellite calendar 354-1 has data of which the measurement start time is “0:00 of Aug. 1, 2008”. The actual position of the GPS satellite “SV2” at “5:45 on Aug. 1, 2008”, is “(Xm32, Ym32, Zm32)” and the actual error of the atomic clock is “Δtm32”.

The CPU 310 periodically (for example, once every 4 hours) receives the precise satellite calendars from the external system 2. Then, the CPU 310 performs a process of processing a data format to store the received precise satellite calendars in the precise satellite database 353. Specifically, plural precise satellite calendars 354 of which the start times correspond to the plural predicted satellite calendars 352 stored in the predicted satellite calendar database 351 are created and stored in the precise satellite calendar database 353.

FIG. 11 is a diagram illustrating the data structure of the measurement error database 355. The measurement error database 355 is a database in which plural measurement error data 356 (356-1, 356-2, 356-3, . . . ) is stored by start time. The respective measurement error data 356 include the measurement error of the corresponding period and the corresponding GPS satellite. In addition, the measurement error data include satellite average measurement errors 31 (31-S1, 31-S2, . . . , and 31-S32) which are acquired by averaging the measurement errors of all the periods for each satellite and period average measurement errors 41 (41-P1, 41-P2, . . . , and 41-P28) which are acquired by averaging the measurement errors of all the GPS satellites for each period.

For example, the measurement error data 356-1 is data of which the start time is “0:00 on Aug. 1, 2008”. The measurement error in the “second period” of the GPS satellite “SV2” is “E22”. The satellite average measurement error of the GPS satellite “SV2” is “ES2” and the period average measurement error for the “second period” is “EP2”.

In the long-term predicted ephemeris providing process, the CPU 310 calculates the measurement errors in the periods for the GPS satellites in accordance with the above-mentioned principle. The satellite average measurement errors 31 and the period average measurement errors 41 are calculated using the calculated measurement errors. The measurement error data 356 is created by correlating them with the start times and is then stored in the measurement error database 355.

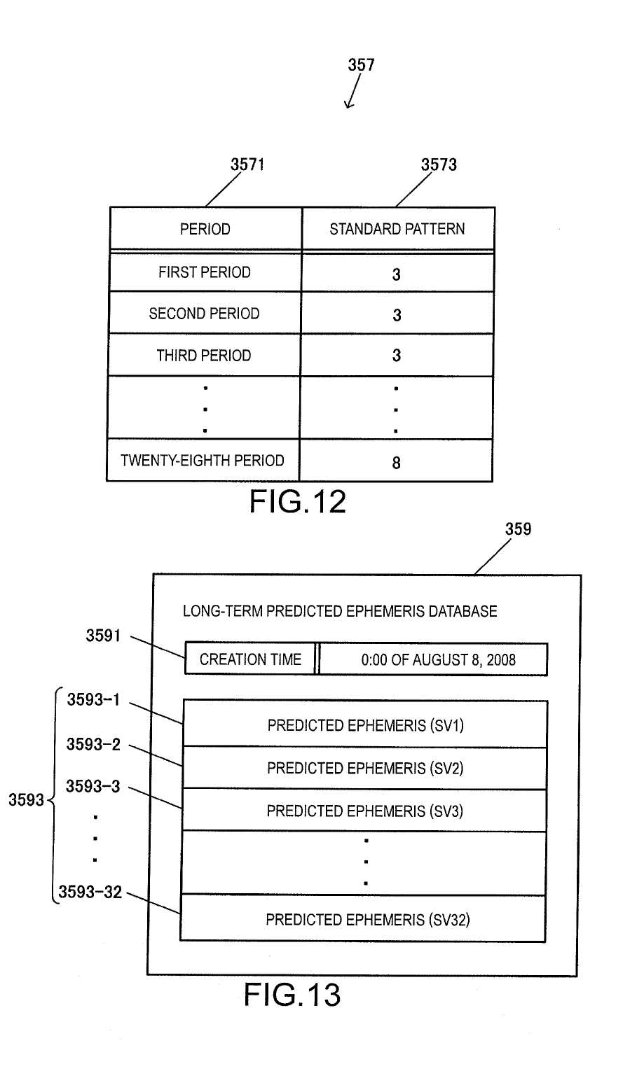

FIG. 12 is a diagram illustrating the data structure of the standard pattern data 357. The standard pattern data 357 includes periods 3571 and standard patterns 3573, which are correlated with each other. For example, the standard pattern of the twenty-eighth period is set to “8”.

In the long-term predicted ephemeris creating process, the CPU 310 sets the standard patterns in accordance with the above-mentioned principle. The set standard patterns 3573 are correlated with the periods 3571 and are stored in the standard pattern data 357.

FIG. 13 is a diagram illustrating the data structure of the long-term predicted ephemeris data 359. The long-term predicted ephemeris data 359 includes the creation times 3591 of the long-term predicted ephemeris data and the predicted ephemeris 3593 (3593-1 to 3593-32) of the GPS satellites SV1 to SV32 which are correlated with each other.

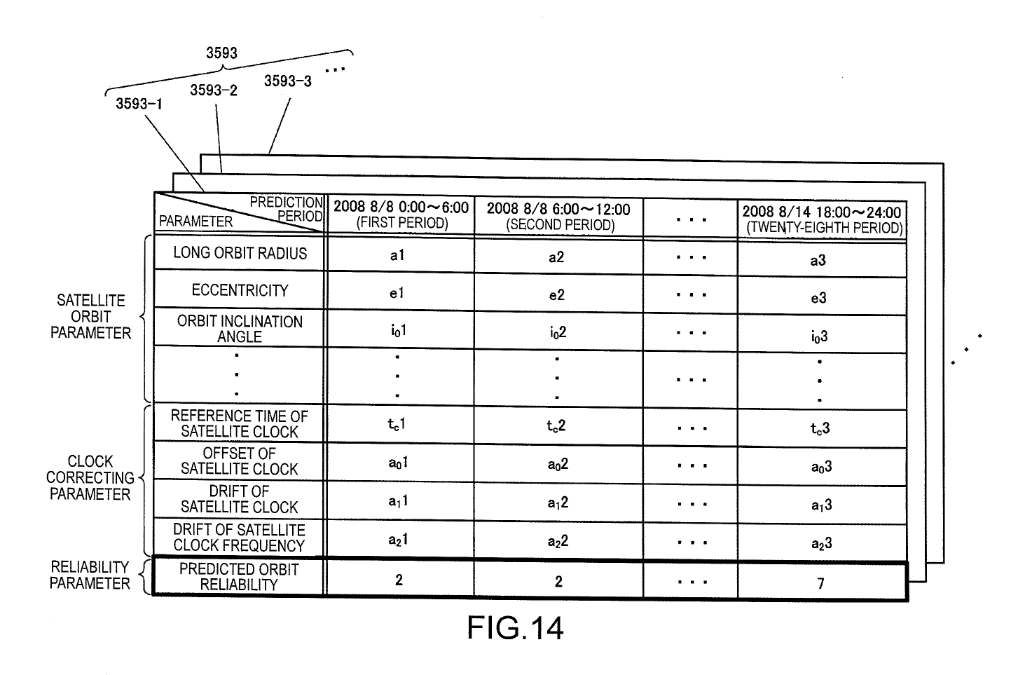

FIG. 14 is a diagram illustrating the data structure of the predicted ephemeris 3593. The predicted ephemeris 3593 (3593-1, 3593-2, . . . , and 3593-32) includes values of Keppler's satellite orbit parameters such as the long orbit radius, the eccentricity, and the orbit inclination angle, values of clock correcting parameters such as reference times of satellite clocks, offsets of the satellite clocks, the drift of the satellite clock, and the drift of the satellite clock frequencies, and the predicted orbit reliabilities as the reliability parameter in the respective prediction periods, which are correlated with each other.

In the long-term predicted ephemeris creating process, the CPU 310 calculates the values of the satellite orbit parameters, the clock correcting parameters, and the reliability parameter for each GPS satellite SV and creates the predicted ephemeris 3593. The predicted ephemeris 3593 created for all the GPS satellites SV are collected and correlated with the creation times 3591 to create and store the long-term predicted ephemeris data 359 on the hard disk 350.

### 5. Flow of Processes

FIG. 15 is a flowchart illustrating a flow of the long-term predicted ephemeris providing process performed by the server system 3 by allowing the CPU 310 to read and execute the long-term predicted ephemeris providing program 341 stored in the ROM 340.

First, the CPU 310 determines whether the predicted satellite calendar and the precise satellite calendar are received from the external system 2 (step A1). When it is determined that they are not received (NO in step A1), the process of step A9 is performed.

When it is determined they are received (YES in step A1), the CPU 310 processes the predicted satellite calendar and the precise satellite calendar and creates plural predicted satellite calendars 352 and precise satellite calendars 354 having the same start time and the same period (step A3). The CPU 310 stores the predicted satellite calendars 352 and the precise satellite calendars 354 in the predicted satellite calendar database 351 and the precise satellite calendar database 353 of the hard disk 350, respectively (step A5).

Subsequently, the CPU 310 performs the measurement error calculating process (step A7). Specifically, the CPU 310 calculates the measurement errors in accordance with the above-mentioned principle and creates the measurement error data 356. The created measurement error data 356 is stored in the measurement error database 355.

The CPU 310 determines whether the creation time of the long-term predicted ephemeris comes in step A9. In this embodiment, it is assumed that the long-term predicted ephemeris is created once every 4 hours. When it is determined that the creation time does not come in yet (NO in step A9), the CPU 310 performs the process of step A13.

When it is determined that the creation time of the long-term predicted ephemeris comes in step A9 (YES in step A9), the CPU 310 performs the long-term predicted ephemeris creating process by reading and executing the long-term predicted ephemeris creating program 3411 stored in the ROM 340 (step A11).

FIGS. 16 and 17 are flowcharts illustrating the flow of the long-term predicted ephemeris creating process.

First, the CPU 310 performs the standard pattern setting process (step B1). Specifically, the standard patterns 3573 for the periods 3571 are set in accordance with the above-mentioned principle using the measurement error data 356 stored in the measurement error database 355. The periods 3571 and the standard patterns 3573 are correlated to create the standard pattern data 357, which is stored on the hard disk 350.

The CPU 310 relatively estimates the satellite average measurement errors of the GPS satellites and determines the correction values of the standard patterns of the GPS satellites (step B3). By correcting the standard patterns using the determined correction values, the predicted orbit reliabilities which are the values of the reliability parameter in the periods are determined (step B5).

Thereafter, the CPU 310 determines the prediction periods on the basis of the present creation time (current time) of the long-term predicted ephemeris (step B7). That is, the CPU 310 sets the period from the present creation time to the time after one week as the creation time and determines the periods into which the creation time is divided every 6 hours as the prediction periods.

Subsequently, the CPU 310 performs the processes of loop A on each of the GPS satellites SV (steps B9 to B25). In the processes of loop A, the CPU 310 performs the processes of loop B on each of the prediction periods determined in step B7 (steps B11 to B21).

In the processes of loop B, the CPU 310 reads the predicted positions of the corresponding GPS satellite SV at the times of the corresponding prediction period from the newest predicted satellite calendar 352 stored in the predicted satellite calendar database 351 on the hard disk 350 (step B13).

The CPU 310 calculates the predicted orbit of the corresponding GPS satellite SV in the prediction period using the read predicted positions and Keppler's elliptical orbit model and acquires the values of Keppler's satellite orbit parameters (step B15). Since the specific method of calculating the predicted orbit is widely known, its detailed description will be omitted.

Thereafter, the CPU 310 reads the predicted clock error of the corresponding GPS satellite SV at the times of the corresponding prediction period from the newest predicted satellite calendar 352 (step B17). Then, the CPU 310 acquires the values of the clock correcting parameters of the GPS satellite in the corresponding prediction period using the read predicted clock error (step B19).

The predicted clock error “Δt” at the time “t” can be approximated by Expression 1 using the reference time “t_{c}” of the satellite clock, the offset “a₀” of the satellite clock, the drift “a₁” of the satellite clock, and the drift “a₂” of the satellite clock frequency, which are the clock correcting parameters.

Δt=a₀+a₁(t−t_{c})+a₂(t−t_{c})² Expression 1

Expression 1 is a clock error model expression for approximating a temporal variation of the predicted clock error. By performing the approximate calculation, for example, by the use of the least square method using the predicted clock errors “Δt” at the times included in the predicted satellite calendar 351 as sampling data, the values of the clock correcting parameters can be calculated. Thereafter, the CPU 310 performs the flow of processes on the next prediction period.

The CPU 310 performs the processes of steps B13 to B19 on all the prediction periods and then ends the processes of loop B (step B21). Thereafter, the CPU 310 collects the values of the satellite orbit parameters calculated in step B15 for all the prediction periods, the values of the clock correcting parameters calculated in step B19, and the value (predicted orbit reliability) of the reliability parameter determined in step B5 and creates the predicted ephemeris 3593 of the corresponding GPS satellite SV (step B23). The CPU 310 performs the flow of processes on the next GPS satellite SV.

The CPU 310 performs the processes of steps B11 to B23 on all the GPS satellites SV and then ends the processes of loop A (step B25). Thereafter, the CPU 310 collects and correlates the predicted ephemeris 3593 of all the GPS satellites SV created in step B23 with the creation times 3591 to create the long-term predicted ephemeris data 359 and the generated long-term predicted ephemeris data 359 is stored on the hard disk 350 (step B27). Then, the CPU 310 ends the long-term predicted ephemeris creating process.

Returning to the long-term predicted ephemeris providing process shown in FIG. 15 again, after performing the long-term predicted ephemeris creating process, the CPU 310 determines whether the request signal for the long-term predicted ephemeris data 359 is received from the mobile phone 4 (step A13). When it is determined that the request signal is not received (NO in step A13), the process of step A1 is performed again.

When it is determined that the request signal is received (YES in step A13), the CPU 310 transmits the long-term predicted ephemeris data 359 stored on the hard disk 350 to the mobile phone 4 as the request source (step A15). Then, the CPU 310 performs the process of step A1 again.

### 6. Operational Advantage

According to this embodiment, the server system 3 of the positioning system 1 analyzes a variation in the accuracy of the predicted positions included in the predicted satellite calendars by comparing the predicted positions included in the predicted satellite calendars, which are acquired by predicting the positions of the GPS satellites SV in a time series and received from the external system 2, with the actual positions included in the precise satellite calendars storing the actual positions of the positioning satellites in a time series. Then, the server system 3 determines the reliability in each of the prediction periods of the long-term predicted ephemeris, including the values of the satellite orbit parameters of the predicted satellite orbits in each of the successive plural prediction periods, on the basis of the analysis result. Then, the server system 3 provides the determination result of the reliability to the mobile phone 4 along with the long-term predicted ephemeris.

More specifically, the measured distance error is calculated, which is the difference between the distance between the predicted position and the measured position and the distance between the actual position and the measured position. The clock distance error is calculated, which is the difference between the distance-converted value of the predicted clock error and the distance-converted value of the actual clock error. Subsequently, the sum of the measured distance error and the clock distance error is calculated as the measurement error. The period average measurement error is calculated by averaging the measurement errors by periods and the standard pattern is set on the basis of the temporal variation of the period average measurement error.

Thereafter, the satellite average measurement error is calculated by averaging the measurement errors by GPS satellites, and the correction values of the standard patterns are determined by relatively estimating the satellite average measurement errors for the GPS satellites. Then, the predicted orbit reliability which is an indicator value of the reliability of the predicted orbit in the prediction periods is determined by correcting the standard patterns using the determined correction values.

The actual position of the GPS satellite SV is the actual position at which the GPS satellite SV is actually located at that time. Accordingly, when the measurement error calculated using the predicted position and the actual position is great, it can be said that the accuracy of the predicted position is low and the reliability of the predicted satellite orbit predicted on the basis of the predicted position is low. Accordingly, the standard pattern for the period of which the period average measurement error is great is set to decrease the reliability, the standard pattern for the satellite of which the satellite average measurement error is relatively small in the GPS satellites is set to enhance the reliability, and the standard pattern for the satellite of which the satellite average measurement error is relatively great is set to decrease the reliability. Therefore, it is possible to accurately determine the reliability of the long-term predicted ephemeris and thus to provide the proper value of the reliability parameter to the mobile phone 4.

### 7. Modified Example

### 7-1. Positioning System

Although the positioning system 1 including the server system 3 and the mobile phone 4 has been exemplified in the above-mentioned embodiments, the invention is not limited to the positioning system. For example, the invention may be applied to electronic apparatuses such as a notebook computer, a PDA (Personal Digital Assistant), and a car navigation apparatus having a positioning device, instead of the mobile phone 4.

Although the server system 3 has been exemplified as a kind of information providing apparatus in the above-mentioned embodiments, the information providing apparatus is not limited to the server system 3. For example, a general-purpose PC and the like may be employed.

### 7-2. Satellite Positioning System

Although the GPS has been exemplified as the satellite positioning system in the above-mentioned embodiments, other satellite positioning systems such as WAAS (Wide Area Augmentation System), QZSS (Quasi Zenith Satellite System), GLONASS (GLObal NAvigation Satellite System), and GALILEO may be employed.

### 7-3. Correction of Standard Pattern Based on Time-Series Variation of Measurement Error

Instead of or with the relative estimation of the satellite measurement errors, the standard patterns may be corrected on the basis of the time-series variation in the start time of the satellite measurement errors.

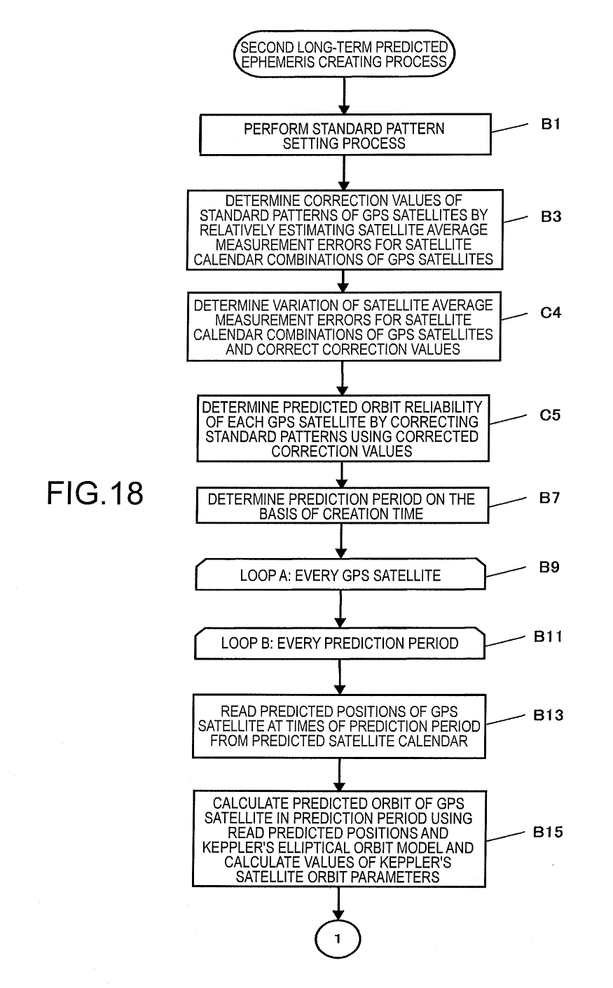

FIG. 18 is a flowchart illustrating a part, corresponding to the long-term predicted ephemeris creating process shown in FIG. 16, of a second long-term predicted ephemeris creating process performed by the CPU 310. The same steps as the long-term predicted ephemeris creating process are referenced by the same reference numerals and the description thereof is omitted. Only the part different from the long-term predicted ephemeris creating process will be described.

In the second long-term predicted ephemeris creating process, after determining the correction values of the standard patterns in step B3, the CPU 310 determines the variation of the satellite average measurement errors based on the time-series variation in the start times and corrects the correction values of the standard patterns for each GPS satellite (step C4).

Specifically, when the satellite average measurement error tends to increase as the start time gets close to the creation time (present time), “1” is added to the correction value. When the satellite average measurement error tends to decrease, “1” is subtracted from the correction value. When the increase or the decrease is not determined, the correction value is maintained without any change. A value (for example, “2” or “3”) greater than “1” may be added to or subtracted from the correction value. The variation of the satellite average measurement error can be determined by calculating a differential value, or the like.

Thereafter, the CPU 310 determines the predicted orbit reliability in each period by correcting the standard pattern using the corrected correction value (step C5). Then, the CPU 310 performs the processes of steps B7 and subsequent thereto.

### 7-4. Satellite Position Error

Although it has been described in the above-mentioned embodiment that the predicted orbit reliability is determined using the measurement error, the predicted orbit reliability may be determined using the error of the satellite position (hereinafter, referred to as a “satellite position error”) instead of the measurement error. The satellite position error can be calculated as a distance between the predicted position included in the predicted satellite calendar and the actual position included in the precise satellite calendar. By replacing the measurement error with the satellite position error, it is possible to determine the predicted orbit reliability in accordance with the above-mentioned principle.

### 7-5. Setting of Standard Pattern

Although it has been described in the above-mentioned embodiment, as shown in FIG. 3, that the standard pattern is set by the day, the standard pattern may be set by the period. That is, it is determined in what period average measurement error range 3431 the period average measurement error of each period is included with reference to the measurement error-basic value correlation table 343 shown in FIG. 8. The standard pattern is set by reading the basic value 3433 corresponding to the determined period average measurement error range 3431 and setting the basic values in these periods.

### 7-6. Average Measurement Error

Although it has been described in the above-mentioned embodiment that the standard pattern is set on the basis of the period average measurement error, the standard pattern may be set on the basis of the maximum value of the measurement error calculated by the periods (period maximum measurement error). Instead of determining the correction value of the standard pattern by relatively estimating the satellite average measurement errors, the correction value of the standard pattern may be determined by relatively estimating the maximum value of the measurement error calculated by the satellites (satellite maximum measurement error).

### 7-7. Creation of Long-Term Predicted Ephemeris

Although it has been described in the above-mentioned embodiments that the server system 3 creates and provides the long-term predicted ephemeris data to the mobile phone 4, the mobile phone 4 itself may create the long-term predicted ephemeris data. That is, the mobile phone 4 periodically acquires the predicted satellite calendars and the precise satellite calendars from the external system 2 and creates the long-term predicted ephemeris data by performing the long-term predicted ephemeris creating process using the acquired predicted satellite calendars and the acquired precise satellite calendars. The same is true when electronic apparatuses such as a notebook computer, a PDA, and a car navigation apparatus having a positioning device are employed instead of the mobile phone 4.

In the above-mentioned embodiments, it has been described that the server system 3 creates the long-term predicted ephemeris data at a predetermined time interval (for example, once every four hours) in advance and transmits the created long-term predicted ephemeris data when receiving a request for the long-term predicted ephemeris data from the mobile phone 4. However, instead of this configuration, when receiving the request for the long-term predicted ephemeris data from the mobile phone 4, the server system 3 may create and transmit the long-term predicted ephemeris data to the mobile phone 4.

### 7-8. Creation Period

Although it has been described in the above-mentioned embodiments that the long-term predicted ephemeris is created using the period of one week from the creation time of the long-term predicted ephemeris as the creation period, the creation period may be a period longer than one week (for example, two weeks) or may be a period shorter than one week (for example, three days). The ephemeris as the navigation data transmitted from the GPS satellite SV generally has an availability period of about 4 hours, but the long-term predicted ephemeris has an availability period longer than that of the ephemeris as the navigation data transmitted from the GPS satellite SV. For example, it is preferable that the available period is one day or more.

### 7-9. Prediction Period

Although it has been described in the above-mentioned embodiments that the length of the prediction period is 6 hours, the length of the prediction period is not limited to it, but may be properly set to, for example, 4 hours or 8 hours.

What is claimed is:

1. A method of determining a reliability of long-term predicted orbit data, comprising:
analyzing a variation in the accuracy of time-series predicted positions included in predicted position data by comparing the predicted positions included in the predicted position data, which is acquired by predicting a position of a positioning satellite in a time series, with actual positions of the positioning satellite corresponding to the predicted positions; and
determining the reliability in each of the prediction periods of the long-term predicted orbit data including predicted satellite orbits in a plurality of successive prediction periods on the basis of the analysis result.

2. The method according to claim 1, wherein the analyzing of the variation in accuracy includes:
comparing the predicted positions included in each of a plurality of the predicted position data having different prediction times with the corresponding actual positions; and
calculating a variation pattern in the accuracy of the predicted positions with the lapse of time when the positions of the positioning satellite are predicted in a time series by statistically processing the comparison result, and
wherein the determining of the reliability includes determining the reliability in each of the prediction periods of the long-term predicted orbit data on the basis of the variation pattern.

3. The method according to claim 2, wherein the predicted position data includes the predicted positions of a plurality of the positioning satellites,
wherein the comparing of the predicted positions with the actual positions includes comparing the predicted positions of each of the positioning satellites with the actual positions, and
wherein the calculating of the variation pattern includes calculating the variation pattern which is standard in the positioning satellites by statistically processing the comparison results of the positioning satellites.

4. The method according to claim 3, wherein the long-term predicted orbit data includes data in the prediction periods for the positioning satellites,
wherein the method further comprises relatively estimating the comparison results of the positioning satellites with respect to each other,
wherein the determining of the reliability includes correcting the variation pattern for each positioning satellite on the basis of the relative estimation result and determining the reliability of each of the long-term predicted orbit data in each of the prediction periods for each positioning satellite.

5. The method according to claim 3, wherein the analyzing of the variation in accuracy includes collecting the comparison results of the predicted position data every prediction time of the predicted position data for each positioning satellite, and
wherein the determining of the reliability includes correcting the variation pattern for each positioning satellite on the basis of the time-series variation of the prediction times in the comparison results collected every prediction time of the predicted position data and determining the reliability in each prediction period of the long-term predicted orbit data for each positioning satellite.

6. The method according to claim 5, wherein the determining of the reliability includes correcting the variation pattern and then determining the reliability for only the positioning satellite of which the comparison result of the predicted positions with the actual positions does not satisfy a predetermined fault condition, out of the plurality of positioning satellites.

7. A method of providing long-term predicted orbit data, comprising:
creating long-term predicted orbit data including predicted satellite orbits in a plurality of successive prediction periods;
analyzing a variation in an accuracy of time-series predicted positions included in predicted position data by comparing the predicted positions included in the predicted position data, which is acquired by predicting a position of a positioning satellite in a time series, with actual positions of the positioning satellite corresponding to the predicted positions;
determining the reliability in each of the prediction periods of the created long-term predicted orbit data on the basis of the analysis result; and
providing the created long-term predicted orbit data and the determination result to a positioning device.

8. An information providing apparatus comprising:
a creation unit creating long-term predicted orbit data including predicted satellite orbits in a plurality of successive prediction periods;
an analysis unit analyzing a variation in an accuracy of the time-series predicted positions included in predicted position data by comparing the predicted positions included in the predicted position data, which is acquired by predicting a position of a positioning satellite in a time series, with actual positions of the positioning satellite corresponding to the predicted positions;
a determination unit determining the reliability in each of the prediction periods of the long-term predicted orbit data created by the creation unit on the basis of the analysis result of the analysis unit; and
a provision unit providing the long-term predicted orbit data created by the creation unit and the determination result of the determination unit to a positioning device.
